(19) United States
(12) Patent Application Publication
(10) Pub. No.: US 2022/0084415 A1
(43) Pub. Date: Mar. 17, 2022

(54) FLIGHT PLANNING METHOD AND RELATED APPARATUS

(71) Applicant: SZ DJI TECHNOLOGY CO., LTD., Shenzhen (CN)

(72) Inventors: Renli SHI, Shenzhen (CN); Jinsong LI, Shenzhen (CN); Gang HE, Shenzhen (CN); Zhenhao HUANG, Shenzhen (CN)

(21) Appl. No.: 17/456,608

(22) Filed: Nov. 26, 2021

Related U.S. Application Data
(63) Continuation of application No. PCT/CN2019/088626, filed on May 27, 2019.

(51) Int. Cl. G08G 5/00; B64C 39/02

(52) U.S. Cl. CPC G08G 5/003; G08G 5/0086; B64C 2201/127; B64C 39/024; G08G 5/0069

(57) ABSTRACT

A flight planning method includes selecting a plurality of target feature points on an inclined ground object, determining an inclination angle of the inclined ground object with respect to a horizontal plane based on position information of the plurality of target feature points, and determining a control parameter of an unmanned aerial vehicle (UAV) flying with respect to the inclined ground object according to the inclination angle. The control parameter is used to determine a flight route of the UAV.

### CROSS-REFERENCE TO RELATED APPLICATION

This application is a continuation of International Application No. PCT/CN2019/088626, filed May 27, 2019, the entire content of which is incorporated herein by reference.

### TECHNICAL FIELD

The present disclosure generally relates to the computer technology field and, more particularly, to a flight planning method and a related apparatus.

### BACKGROUND

With the development of unmanned aerial vehicle (UAV) technology and measurement technology, aerial measurement using a UAV is used as a powerful supplement to the conventional aerial photography measurement method. Thus, the UAV is widely used in scenes such as landslide detection and high slope inspection.

Currently, most UAVs creating models for inclined ground objects mainly include performing flight route planning on the inclined ground objects on the horizontal plane. A small number of UAVs can use ground station software to realize the terrain following flight route planning for the inclined ground objects. In terrain following flight solution adopted by this type of ground station software, measurement data obtained by a rough flight of the UAV is used to construct a digital surface model (DSM), and the DSM is used to perform terrain following flight route planning. However, the flight route planning performed by using this manner has a low resolution accuracy, which is difficult to meet needs for fine sampling. Moreover, the modeling process takes a long time. Thus, real-time performance of the flight route planning process for the inclined ground objects is poor, and user experience is poor.

### SUMMARY

Embodiments of the present disclosure provide a flight planning method includes selecting a plurality of target feature points on an inclined ground object, determining an inclination angle of the inclined ground object with respect to a horizontal plane based on position information of the plurality of target feature points, and determining a control parameter of an unmanned aerial vehicle (UAV) flying with respect to the inclined ground object according to the inclination angle. The control parameter is used to determine a flight route of the UAV.

Embodiments of the present disclosure provide a flight planning system, including a UAV and a control terminal. The control terminal is configured to select a plurality of target feature points on an inclined ground object, determine an inclination angle of the inclined ground object with respect to a horizontal plane based on position information of the plurality of target feature points, and determine a control parameter of the UAV flying with respect to the inclined ground object. The control parameter is used to determine a flight route of the UAV.

Embodiments of the present disclosure provide a flight planning apparatus, including a processor and a memory. The memory stores a computer program that, when executed by the processor, causes the processor to select a plurality of target feature points on an inclined ground object, determine an inclination angle of the inclined ground object with respect to a horizontal plane based on position information of the plurality of target feature points, and determine a control parameter of an unmanned aerial vehicle (UAV) flying with respect to the inclined ground object. The control parameter is used to determine a flight route of the UAV.

### BRIEF DESCRIPTION OF THE DRAWINGS

FIG. 1A is a schematic structural diagram of a flight plan system according to some embodiments of the present disclosure.

FIG. 1B-1C are schematic diagrams each showing an inclined ground object according to some embodiments of the present disclosure.

FIG. 2A is a schematic diagram showing a scene of flight planning according to some embodiments of the present disclosure.

FIG. 2B is a schematic diagram showing a flight route in a zigzag shape based on FIG. 2A according to some embodiments of the present disclosure.

FIG. 3 is a schematic diagram of a predetermined overlap degree based on FIG. 2B according to some embodiments of the present disclosure.

FIG. 4 is a schematic flowchart of a flight planning method according to some embodiments of the present disclosure.

FIG. 5 is a schematic diagram showing calculation of a distance between a computational UAV and an inclined ground object according to some embodiments of the present disclosure.

FIG. 6 is a schematic diagram of calculation of a longitudinal travel distance according to some embodiments of the present disclosure.

FIG. 7 is a schematic flowchart of another flight planning method according to some embodiments of the present disclosure.

FIG. 8 is a schematic diagram showing adjustment of an angle of a gimbal of the UAV according to some embodiments of the present disclosure.

FIG. 9 is a schematic structural diagram of a flight plan apparatus according to some embodiments of the present disclosure.

### DETAILED DESCRIPTION OF THE EMBODIMENTS

The technical solutions of embodiments of the present disclosure are described in detail in connection with the accompanying drawings.

To solve a technical problem of poor real-time performance of a flight route planning process on the inclined ground object in the existing technologies, embodiments of the present disclosure provide a flight planning method, which is applied to an unmanned aerial vehicle (UAV) or a control terminal. The method may include selecting a plurality of target feature points on an inclined ground object, determining an inclination angle of the inclined ground object relative to a horizontal plane based on position information of the plurality of target feature points, and determining a control parameter of flight of the UAV relative to the inclined ground object according to the inclination angle. The control parameter may be used to determine a flight route of the UAV. With the above method, the flight route planning for the inclined ground object may be realized, and the control parameter may be determined in real-time. Thus, the more accurate and effective flight route planning may be performed for the inclined ground object based on the control parameter. Therefore, the real-time performance of the flight route planning process for the inclined ground object may be improved, the work efficiency may be increased, and the user experience may be enhanced.

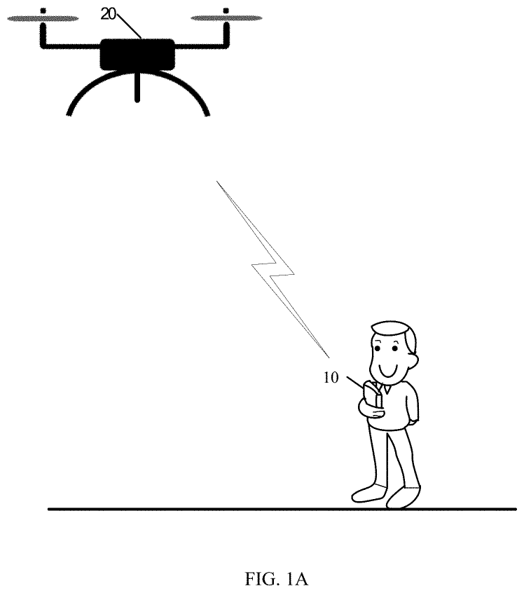

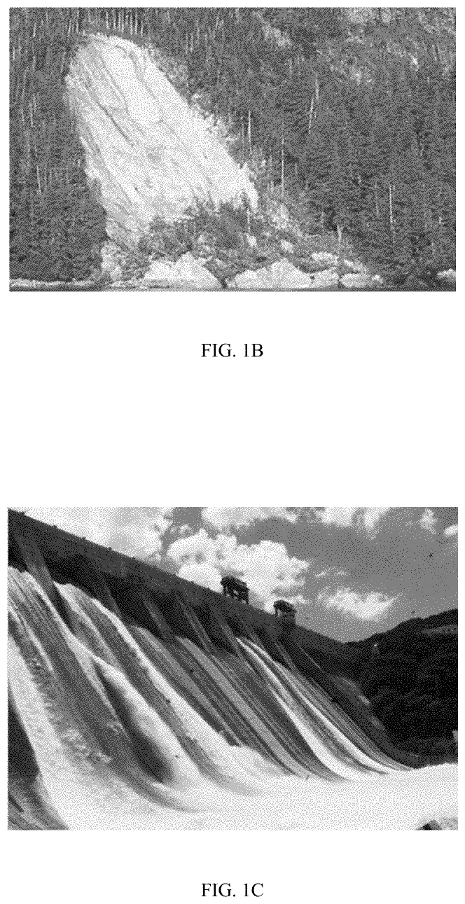

Embodiments of the present disclosure further provide a flight plan system, which is configured to perform a flight planning method. FIG. 1A is a schematic structural diagram of a flight plan system according to some embodiments of the present disclosure. The flight plan system includes a control terminal 10 and a UAV 20. The control terminal 10 may be configured to establish communication with the UAV 20 to control flight of the UAV 20.

The control terminal 10 may include one or more of a remote controller, a smartphone, a tablet computer, a laptop, a ground station, or a wearable apparatus (such as a watch or a wristband). The UAV 20 may include a rotary-wing UAV, such as a quadrotor UAV, a hexarotor UAV, or an eight-rotor UAV, a fixed-wing UAV, or a combination of the rotary-wing UAV and the fixed-wing UAV, which is not limited here. The UAV 20 may include a power system. The power system may be configured to provide flight power for the UAV. The power system may include one or more of a propeller, a motor, or an electronic speed controller (ESC). The UAV 20 may further include a position information collection device, such as a global positioning system (GPS) or a real-time kinematic (RTK) carrier phase differential positioning system. The position information collection device may be configured to record position information of the plurality of target feature points, for example coordinate information of latitude and longitude. In some embodiments, the UAV may further include a gimbal. A photographing device may be mounted at a main body of the UAV through the gimbal. The gimbal may include a multi-axis transmission and stabilization system. A gimbal motor may be configured to compensate a photographing angle of the imaging device by adjusting a rotation angle of a rotation axis and prevent or reduce shaking of the imaging device by arranging an appropriate buffer mechanism. In some other embodiments, the photographing device may also be directly arranged at the UAV. The gimbal may not be needed to carry the photographing device and connect the photographing device to the UAV.

In some embodiments, in the flight plan system shown in FIG. 1A, the control terminal 10 is configured to execute the flight planning method. In some embodiments, the control terminal 10 may be configured to select the plurality of target feature points of the inclined ground object. The control terminal 10 may be configured to determine the inclination angle of the inclined ground object relative to the horizontal plane based on the position information of the plurality of target feature points and determine the control parameter of the flight of the UAV 20 relative to the inclined ground object according to the inclination angle. In some embodiments, the control terminal 10 may be configured to determine the flight route of the UAV 20 according to the control parameter. The control terminal 10 may be further configured to send the flight route to the UAV 20. In some other embodiments, the control terminal 10 may be configured to send the control parameter to the UAV 20. The UAV 20 may be configured to generate the flight route according to the control parameter.

In some other embodiments, in the flight plan system shown in FIG. 1A, the UAV 20 is configured to execute the flight planning method. In some embodiments, the UAV 20 may be configured to select the plurality of target feature points on the inclined ground object and determine the inclination angle of the inclined ground object relative to the horizontal plane based on the position information of the plurality of target feature points. The UAV 20 may determine the control parameter of the flight of the UAV relative to the inclined ground object according to the inclination angle. In some embodiments, the UAV 20 may be also configured to determine a flight route according to the control parameter.

In embodiments of the present disclosure, the control terminal 10 may be configured to send a control instruction to the UAV 20. The UAV 20 may be configured to select the plurality of target feature points on the inclined ground object according to the control instruction and record the position information of the plurality of target feature points. In some embodiments, the UAV 20 may be further configured to send the position information of the plurality of target feature points to the control terminal 10.

In some embodiments, before selecting the plurality of target feature points on the inclined ground object, the UAV may be set to an RTK mode. As such, the UAV may obtain the position information with higher precision. In embodiments of the present disclosure, by setting the UAV to the RTK mode, centimeter-level positioning accuracy may be achieved. Thus, the position information of each target feature point may be more accurate.

The inclined ground object in embodiments of the present disclosure may refer to an inclined object on the ground. For example, the inclined ground object may include a high slope shown in FIG. 1B or a dam shown in FIG. 1C.

The target feature point in embodiments of the present disclosure may refer to a feature point used to determine the inclination angle of the inclined ground object relative to the horizontal plane. In some embodiments, the plurality of target feature points may include at least a first target feature point, a second target feature point, and a third target feature point. For example, in some embodiments, the plurality of target feature points may include the first target feature point, the second target feature point, and the third target feature point. The first target feature point may include a feature point, whose height difference with the second feature point has an absolute value smaller than a first predetermined threshold. For example, the first target feature point and the second target feature point may be considered as approximately on a same straight line. The third target feature point may include a feature point whose height difference with the first target feature point has an absolute value greater than a second preset threshold. In some other embodiments, the third target feature point may include a feature point whose height difference with the second target feature point has an absolute value greater than the second predetermined threshold. In some embodiments, the first target feature point and the second target feature point may be located at a first edge. The third target feature point may be located at a second edge. The first edge may include one of an upper edge and a lower edge of the inclined ground object. The second edge may include the other one of the upper edge and the lower edge of the inclined ground object.

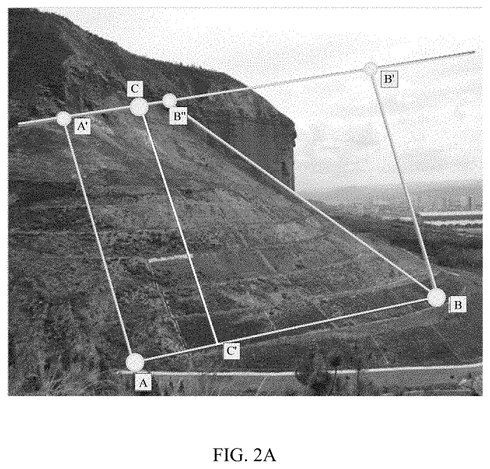

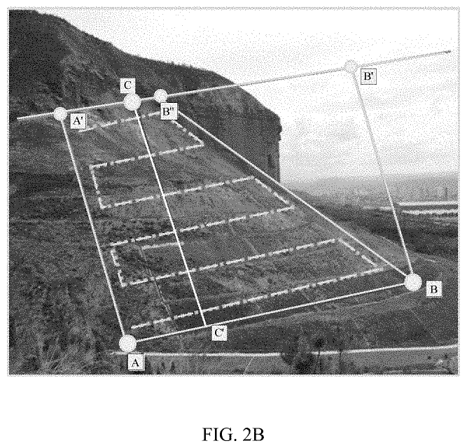

For example, FIG. 2A is a schematic diagram showing a scene of flight planning according to some embodiments of the present disclosure. As shown in FIG. 2A, the first target feature point is feature point A, the second target feature point is feature point B, and the third target feature point is feature point C. Feature point B may include a feature point, whose height difference with feature point A has an absolute value smaller than the first predetermined threshold. For example, feature point B and feature point A may be approximately on a same straight line. Feature point C may include a feature point, whose height difference with feature point A has an absolute value greater than the second predetermined threshold. In some other embodiments, feature point C may include a feature point whose height difference with feature point B has an absolute value greater than the second predetermined threshold. In FIG. 2A, feature point A and feature point B are located at a lower edge of the high slope shown in FIG. 2A, and feature point C is located at an upper edge of the high slope shown in FIG. 2A.

A target measurement area in embodiments of the present disclosure may refer to an operation area of the UAV. The target measurement area may be constructed based on the plurality of target feature points. In FIG. 2A, the target measurement area is constructed based on feature point A, feature point B, and feature point C. In some embodiments, the target measurement area may include a plane area constructed according to feature point A, feature point B, and feature point C. For example, as shown in FIG. 2A, the target measurement area may include AA′B′B or AA′B″B. In some embodiments, the target measurement area may further include a measurement area determined based on an end point. The end point may include an end point determined through user input.

The inclination angle of the inclined ground object with respect to the horizontal plane in embodiments of the present disclosure may refer to an angle between the inclined ground object and the horizontal plane. The inclination angle may be obtained according to the position information of the plurality of target feature points. For example, as shown in FIG. 2A, the inclination angle may be obtained according to the position information of feature point A, the position information of feature point B, and the position information of feature point C. In some embodiments, the inclination angle of the inclined ground object relative to the horizontal plane may include an inclination angle of the target measurement area with respect to the horizontal plane. The position information may be recorded by the position information collection device of the UAV during the process of selecting the plurality of target feature points on the inclined ground object by the UAV.

The flight route in embodiments of the present disclosure may refer to the flight path. The flight route may include a flight route along the inclined ground object. The flight route along the inclined ground object may include but is not limited to a flight route in a “zigzag” shape. For example, FIG. 2B is a schematic diagram showing the flight route in the zigzag shape based on FIG. 2A according to some embodiments of the present disclosure. In some embodiments, the flight route may also include a flight route in other forms, such as a terrain following flight route or a direct flight route compared to the inclined ground object, which is not listed here in embodiments of the present disclosure.

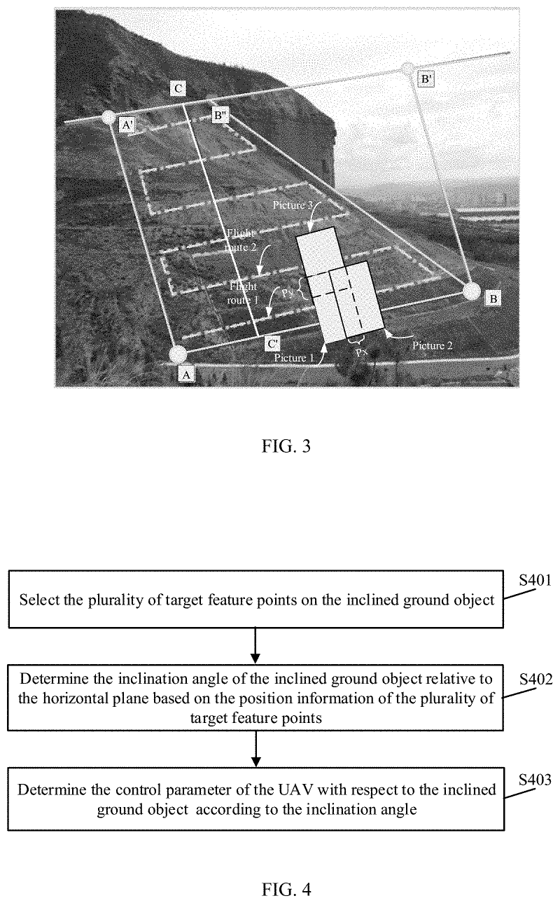

In some embodiments, the flight route may be determined or generated based on the control parameter of the UAV with respect to the inclined ground object. In some embodiments, the control parameter of the UAV flying relative to the inclined ground object may include the control parameter of the UAV flying relative to the target measurement area. In some embodiments, the control parameter may include a travel distance. The travel distance may be determined according to a distance between the UAV and the inclined ground object and a predetermined overlap degree. The predetermined overlap degree may include a predetermined longitudinal overlap degree and/or a predetermined lateral overlap degree. A longitudinal overlap degree may refer to an overlap degree between photos of two neighboring flight routes. A lateral overlap degree may refer to an overlap degree between neighboring photos in a same flight route. FIG. 3 is a schematic diagram of a predetermined overlap degree based on FIG. 2B according to some embodiments of the present disclosure. For example, in FIG. 3, a predetermined longitudinal overlap degree corresponding to photo 1 of flight route 1 and photo 3 of flight route 2 neighboring to flight route 1 is Py. A predetermined lateral overlap degree corresponding to two photos in the same flight route, e.g., photo 1 of flight route 1 and photo 2 neighboring to photo 1 is Px.

In some embodiments, the lateral overlap degree may include a flight direction overlap degree, and the longitudinal overlap degree may include a side overlap degree. In some other embodiments, the lateral overlap degree may include a side overlap degree, and the longitudinal overlap degree may include a fight direction overlap degree. Further, a size of a picture of the photographing device may include a width and a length of the picture. Correspondingly, the travel distance may include a longitudinal travel distance and/or a lateral travel distance. The longitudinal travel distance may refer to a distance between two adjacent routes on the inclined surface object. The lateral travel distance may refer to a travel distance of the UAV for each photo taken in the same flight route for the inclined ground object.

FIG. 4 is a schematic flowchart of a flight planning method according to some embodiments of the present disclosure. In some embodiments, the method includes the following processes.

At S401, the plurality of target feature points on the inclined ground object are selected.

In some embodiments, selecting the plurality of target feature points on the inclined ground object may include controlling the UAV to fly to a first target feature point and recording the position information of the first target feature point. The method may further include controlling the UAV to fly to the second target feature point of the inclined ground object and recording the position information of the second target feature point. The second target feature point may include a feature point whose height difference with the first target feature point has an absolute value smaller than the first predetermined value. The method may further include controlling the UAV to fly to the third target feature point of the inclined ground object and recording the position information of the third target feature point. The third target feature point may include a feature point whose height difference with the first target feature point has an absolute value greater than the second predetermined value.

For example, as shown in FIG. 2A, the UAV is controlled to fly to feature point A of the high slope and records the position information of feature point A; the UAV is controlled to fly to feature point B and records the position information of feature point B; and the UAV is controlled to fly to feature point C and records the position information of feature point C.

In some embodiments, controlling the UAV to fly to the second target feature point of the inclined ground object may include controlling the UAV to fly to an initial target feature point of the inclined ground object, if the height difference between the initial target feature point and the first target feature point is greater than or equal to the first predetermined threshold, outputting warning information, and if the height difference between the initial target feature point and the first target feature point is smaller than the first predetermined threshold, determining the initial target feature point as the second target feature point. In embodiments of the present disclosure, when the height difference is greater than or equal to the first preset threshold, an inaccurate flight route may be avoided by reminding the user. Thus, the error that may occur in the process of planning the terrain following flight route may be reduced.

In some embodiments, to enable the UAV to fly to the second target feature point accurately and quickly, the UAV may be controlled to fly along a first edge to the second target feature point of the inclined ground object.

At S402, the inclination angle of the inclined ground object relative to the horizontal plane is determined based on the position information of the plurality of target feature points.

In some embodiments, to determine the inclination angle of the inclined ground object with respect to the horizontal plane in real-time according to the position information of the plurality of target feature points, determining the inclination angle of the inclined ground object with respect to the horizontal plane based on the position information of the plurality of target feature points may include calculating the inclination angle of the inclined ground object with respect to the horizontal plane according to the position information of the first target feature point, the position information of the second target feature point, and the position information of the third target feature point. In some embodiments, the inclination angle of the inclined ground object with respect to the horizontal plane may include the inclination angle of the target measurement area with respect to the horizontal plane.

FIG. 2A is taken as an example. The inclination angle of the inclined ground object with respect to the horizontal plane is calculated according to the position information of feature point A, the position information of feature point B, and the position information of feature point C. If the target measurement area is AA′B′B, the inclination angle of the inclined ground object with respect to the horizontal plane may include the inclination angle of AA′B′B with respect to the horizontal plane. If the target measurement area is AA′B″B, the inclination angle of the inclined ground object with respect to the horizontal plane may include the inclination angle of AA′B″B with respect to the horizontal plane.

In some embodiments, to accurately and effectively construct the target measurement area according to the plurality of the target feature points to plan an operation area of the UAV in the target measurement area, the first target feature point may be connected to the second target feature point to obtain a straight line between the first target feature point and the second target feature point. A parallel line of the straight line may be drawn through the third target feature point. A first perpendicular line of the parallel line may be drawn through the first target feature point. A second perpendicular line of the parallel line may be drawn through the second target feature point. The first perpendicular line and the second perpendicular line may intersect with the parallel line at the fourth target feature point and the fifth target feature point, respectively. The target measurement area of the inclined ground object may be constructed according to the first target feature point, the second target feature point, the fourth target feature point, and the fifth target feature point.

FIG. 2A is taken as an example. Feature point A in FIG. 2A is the fourth target feature point, and feature point B′ is the fifth target feature point. By connecting feature point A and feature point B, straight line AB between feature point A and feature point B is obtained. The parallel line of straight line AB is drawn through feature point C. The first perpendicular line of the parallel line is drawn through feature point A. The second perpendicular line of straight line AB is drawn through feature point B. The first perpendicular line and the second perpendicular line intersect with the parallel line at feature points A′ and B′, respectively. As such, selected feature point A′ and feature point B′ is ensured to be on the plane where the target measurement area is located. Further, AA′B′B is constructed according to feature point A, feature point B, feature point A′, and feature point B′.

In some embodiments, the process of drawing the first perpendicular line of the parallel line through the first target feature point may include the process of drawing the first perpendicular line of the straight line through the first target feature point. The process of drawing the second perpendicular line of the parallel line through the second target feature point may include the process of drawing the second perpendicular line of the straight line through the second target feature point.

In some embodiments, constructing the target measurement area of the inclined ground object according to the first target feature point, the second target feature point, the fourth target feature point, and the fifth target feature point may include adjusting the position of the fourth target feature point on the parallel line and/or moving the position of the fifth target feature point on the parallel line to cause a quadrilateral formed by the first target feature point, the second target feature point, the fourth target feature point, and the fifth target feature point to match the inclined ground object, and determining the quadrilateral formed by the first target feature point, the second target feature point, the fourth target feature point, and the fifth target feature point to be the target measurement area.

In some embodiments, the user may translate the fourth target feature point or the fifth target feature point on the control terminal, or the inclined ground object may be recognized through intelligent algorithms such as machine learning to identify a suitable target measurement area and each end point of the target measurement area. The method for translating the fourth target feature point or the fifth target feature point is not limited here. In embodiments of the present disclosure, by moving the position of the target feature point, the target measurement area may be matched with the inclined ground object. Thus, the flight route planning for the inclined ground object may be more accurate.

FIG. 2A is taken as an example. Feature point B′ is moved on the parallel line to obtain feature point B″. Feature point B″ is feature point B′ after being moved. Therefore, AA′B″B is constructed according to feature point A, feature point B, feature point A′, feature point B″. As such, target measurement area AA′B″B matches the inclined ground object in FIG. 2A.

In some embodiments, in addition to the method of constructing the target measurement area through the plurality of the target feature points, the target measurement area may be constructed based on end points entered by the user. Compared to the method of constructing the target measurement area by using the plurality of the target feature points, the method of determining the target measurement area based on the end points input by the user may be more flexible.

At S403, the control parameter of the UAV with respect to the inclined ground object is determined according to the inclination angle.

In some embodiments, when the flight planning method of FIG. 4 is applied to the UAV, the UAV may determine the flight route of the UAV according to the control parameters. Thus, the flight route may be planned automatically. The control parameters may be determined by the UAV itself or sent to the UAV by the control terminal.

In some embodiments, when the flight planning method of FIG. 4 is applied to the control terminal, the control terminal may send the control parameters to the UAV. Thus, the UAV may generate the flight route according to the control parameters, or the control terminal may determine the flight route of the UAV according to the control parameters. Thus, the flight route may be planned automatically. In some embodiments, the control terminal may send the flight route to the UAV.

In some embodiments, the control parameter may include the travel distance. Determining the control parameter of the UAV flying relative to the inclined ground object according to the inclination angle may include acquiring the distance between the UAV and the inclined ground object and determining the travel distance of the UAV relative to the target measurement area according to the distance and the determined overlap degree.

In some embodiments, the distance between the UAV and the inclined ground object may be set by the user in advance, calculated according to predetermined photographing parameters, or calculated according to the predetermined photographing parameters when the flight task of the UAV includes a photographing task.

In some embodiments, the flight task includes the photographing task. Obtaining the distance between the UAV and the inclined ground object may include calculating the distance between the UAV and the inclined ground object according to predetermined photographing parameters. The photographing parameters may include a focal length, a pixel size, and resolution. In embodiments of the present disclosure, the resolution may be image resolution that the user expects to obtain when the UAV performs the photographing task. The distance between the UAV and the inclined ground object may be calculated according to the resolution, such that images with the resolution may be obtained by maintaining the distance between the UAV and the inclined ground object when the UAV performs the photographing task. Thus, resolution accuracy may be effectively improved, which satisfies the requirement of fine sampling.

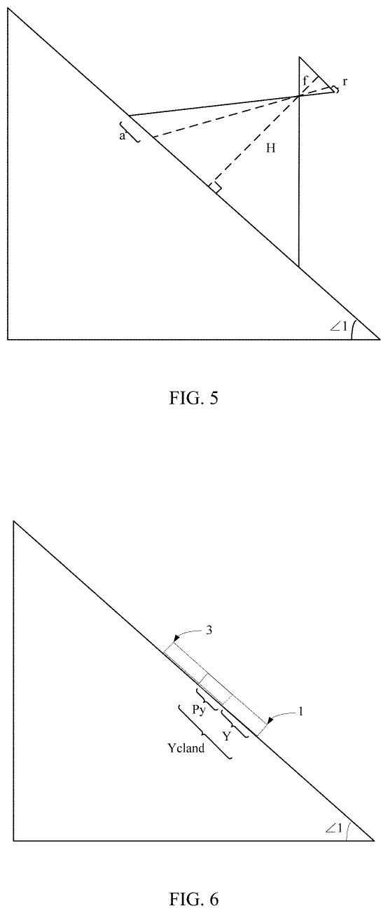

FIG. 5 is a schematic diagram showing calculation of a distance between a UAV and an inclined ground object according to some embodiments of the present disclosure. Taking FIG. 5 as an example, assuming that the focal length is f, the pixel size is r, and the resolution is a, the distance H between the UAV and the inclined ground object may be calculated by the following formula:

$$H = \frac{fa}{r} \qquad 1.1$$

In some embodiments, after the distance between the UAV and the inclined ground object is obtained, determining the travel distance of the UAV relative to the target measurement area according to the distance and the predetermined overlap degree may include calculating the travel distance of the UAV relative to the target measurement area according to the distance, the picture size of the photographing device, and the predetermined overlap degree. In embodiments of the present disclosure, the travel distance of the UAV may be calculated accurately by using the method.

In some embodiments, calculating the travel distance of the UAV relative to the target measurement area according to the distance, the picture size of the photographing device, and the predetermined overlap degree may include, according to the distance, a picture width, and a predetermined longitudinal overlap degree, calculating a longitudinal travel distance of the UAV relative to the target measurement area, and/or, according to the distance, a picture length, and the predetermined lateral overlap degree, calculating a lateral travel distance of the UAV relative to the target measurement area. In embodiments of the present disclosure, the longitudinal travel distance and the lateral travel distance may be effectively calculated through the method.

In some embodiments, calculating the longitudinal travel distance of the UAV relative to the target measurement area according to the distance, the picture width, and the predetermined longitudinal overlap degree may include, according to the distance, the focal length, and the picture width, calculating a projection width of the picture width on the inclined ground object, and according to the projection width and the predetermined longitudinal overlap degree, calculating longitudinal travel distance of the UAV flying with respect to the target measurement area.

FIG. 6 is a schematic diagram showing calculation of a longitudinal travel distance according to some embodiments of the present disclosure. FIG. 6 shows that photo 1 and photo 3 overlap with each other between adjacent flight routes. Taking FIG. 6 as an example, assuming that the focal length is f, the picture width is Ycpicture, and the distance is H, the projection width Ycland of the picture width on the inclined ground object may be calculated by the following formula:

$$Ycland = Ycpicture• \frac{H}{f} \qquad 1.2$$

After Ycland is obtained, the longitudinal travel distance Y of the UAV flying relative to the target measurement area may be calculated by the following formula:

Y=(1−Py)Ycland 1.3

In some embodiments, Y may be represented as follows by inserting formula 1.2 into formula 1.3:

$$Y = ( 1 - Py ) Ycpicture• \frac{H}{f} \qquad 1.4$$

In some embodiments, calculating the lateral travel distance of the UAV relative to the target measurement area according to the distance, the picture length, and the preset lateral overlap degree may include, according to the distance, the focal length, and the picture length, calculating the projection length of the picture length on the inclined ground object, and according to the projection length and the predetermined lateral overlap degree, calculating the lateral travel distance of the UAV relative to the target measurement area.

Assuming that the picture length is Xcpicture, the focal length is f, and the distance is H, the projection length Xcland of the picture length on the inclined ground object may be calculated by the following formula:

$$Xcland = Xcpicture• \frac{H}{f} \qquad 1.5$$

After Xcland is obtained, the lateral travel distance of the UAV flying relative to the target measurement area may be calculated by the following formula:

X=(1−Px)Xcland 1.6

In some embodiments, X may be represented as follows by iterating formula 1.2 into formula 1.3:

$$X = ( 1 - Px ) Xcpicture• \frac{H}{f} \qquad 1.7$$

In some embodiments, the longitudinal travel distance of the UAV relative to the target measurement area may also be projected as a travel distance in a vertical direction and a travel distance in a horizontal direction. For example, the longitudinal travel distance may be projected as the travel distance in the vertical direction and the travel distance in the horizontal direction according to the inclination angle. The flight route of the UAV may be effectively planned in connection with the travel distance in the vertical direction, the travel distance in the horizontal direction and the parameter of the height of the inclined ground object with respect to the horizontal plane.

For example, in some embodiments, assuming that the inclination angle with respect to the inclined ground object is ∠1, travel distance Y1 of the longitudinal travel distance Y projected in the vertical direction may be represented by the following formula:

$$Y 1 = ( 1 - Py ) Ycpicture• \frac{H}{f} •sin∠1 \qquad 1.8$$

In addition, travel distance Y2 of the longitudinal travel distance projected in the horizontal distance may be represented by the following formula:

$$Y 2 = ( 1 - P y ) Ycpicture• \frac{H}{f} •cos1 \qquad 1.9$$

In embodiments shown in FIG. 4, the UAV selects the plurality of target feature points on the inclined ground object, and based on the position information of the plurality of target feature points, determines the inclination angle of the inclined ground object relative to the horizontal plane. Thus, the UAV may determine the control parameter of the UAV flying relative to the inclined ground object according to the inclination angle to determine the flight route to improve the real-time performance during the flight route planning process.

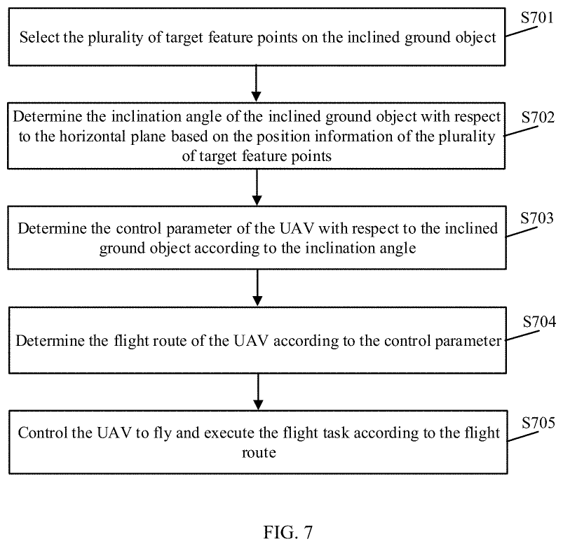

FIG. 7 is a schematic flowchart of another flight planning method according to some embodiments of the present disclosure. A difference from embodiments of FIG. 4 includes that how to determine the flight route based on the control parameter, and a process of how to use the flight route are described in process S704 and process S705 in embodiments of FIG. 7. In some embodiments, the method includes selecting the plurality of target feature points on the inclined ground object (S701), determining the inclination angle of the inclined ground object with respect to the horizontal plane based on the position information of the plurality of target feature points (S702), determining the control parameter of the UAV with respect to the inclined ground object according to the inclination angle (S703), and determining the flight route of the UAV according to the control parameter (S704). For processes S701 to S703, reference may be made to processes S401 to S403 in embodiments of FIG. 4, which are not repeated in embodiments of the present disclosure.

In embodiments of the present disclosure, when the flight planning method of FIG. 7 is applied to the UAV, the UAV may determine the flight route of the UAV according to the control parameter to realize an automatic route planning process. In some embodiments, when the flight planning method of FIG. 7 is applied to the control terminal, the control terminal may determine the flight route of the UAV according to the control parameter to realize an automatic route planning process.

In some embodiments, the control parameter may include the travel distance. Determining the flight route of the UAV according to the control parameter may include determining the travel distance according to the inclination angle, the distance, and the travel distance. For example, the flight route may include the “zigzag” flight route along the inclined ground object shown in FIG. 2B. In embodiments of the present disclosure, the flight route of the UAV may be determined based on the control parameter so that the UAV may accurately plan the flight route. Thus, the route planning process of the UAV may be automated and intelligent, and the efficiency of the flight route planning may be improved.

The method further includes controlling the UAV to fly and execute the flight task according to the flight route (S705).

The flight task may include but be not limited to at least one of a photographing task, a pesticide spray task, a seeding task, a fire monitor task, a search and rescue task, or a military investigation task.

In some embodiments, when the flight planning method of FIG. 7 is applied to the control terminal, the control terminal may send the flight route to the UAV. Thus, the UAV may be controlled to fly and execute the flight task according to the flight route.

In some embodiments, the control terminal may include a send button. When a touch operation on the send button is detected, the control terminal may send the flight route to the UAV.

In some embodiments, the control terminal may include a flight task execution button. When a touch operation on the flight task execution button is detected, the control terminal may send the flight task execution instruction to the UAV so that the UAV may fly and execute the flight task according to the flight task execution instruction.

In some embodiments, the flight task may include the photographing task. Before controlling the UAV to fly and execute the flight task according to the flight route, an angle of the photographing device of the UAV may be adjusted according to the inclination angle. Thus, the photographing device and the inclined ground object may maintain a perpendicular state, i.e., the photographing device may be maintained perpendicular to the inclined ground object. In embodiments of the present disclosure, by adjusting the photographing device and the inclined ground object to maintain the perpendicular state, the requirement of the fine sampling and fine data collection may be satisfied, and perspective distortion may be reduced.

In some embodiments, the control terminal may also include a gimbal adjustment button. The control terminal may adjust the gimbal angle of the UAV by adjusting the gimbal adjustment button to reach the adjusted angle of the photographing device. Thus, the photographing device and the inclined ground object may maintain in the perpendicular state.

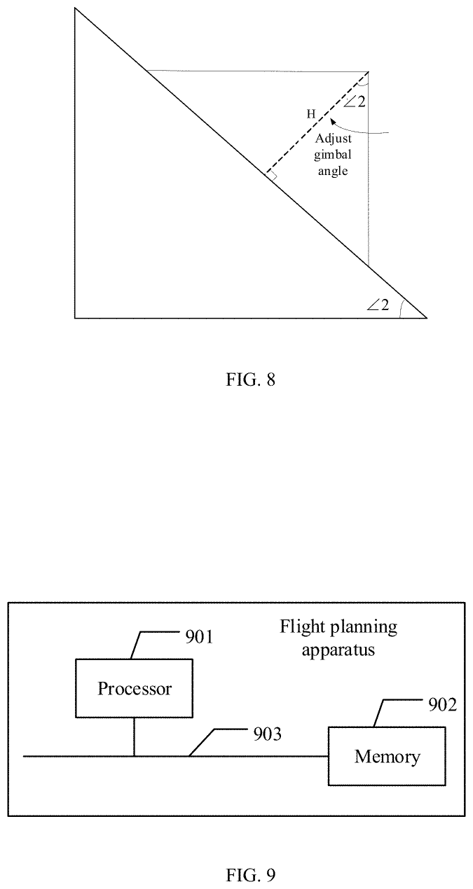

FIG. 8 is a schematic diagram showing adjustment of an angle of a gimbal of the UAV according to some embodiments of the present disclosure. As shown in FIG. 8, the inclination angle of this inclined ground object with respect to the horizontal plane is ∠1, and the gimbal angle ∠2 is initially −90°. The photographing device and the inclined ground object may be maintained to be perpendicular to each other. Thus, the gimbal angle of the UAV ∠2 may be adjusted from −90° to (∠1-90°). In addition, during the process of actually performing the photographing task, the distance between the UAV and the inclined ground object may be H. In this manner, the UAV may obtain images photographed by the UAV, for example, the photos with relatively higher resolution (e.g., previous resolution a).

In embodiments of FIG. 7, after determining the flight route of the UAV according to the control parameter, the UAV may be controlled to perform the flight task such as the photographing task according to the flight route, which satisfies user requirements of fine modeling and fine data collection.

Embodiments of the present disclosure may further provide a flight planning device. The flight planning device may include the UAV or the control terminal. If the flight planning device is the UAV, the UAV can execute the flight planning method in embodiments of the present disclosure and does not need to send the determined control parameters or the flight route. Thus, the processing efficiency of flight planning may be improved. In some embodiments, when the flight planning device is the control terminal, the control terminal may execute the flight planning method described in embodiments of the present disclosure and may send the determined control parameter to the UAV, or send the determined flight route to the UAV. The UAV may generate the flight route based on the control parameter, or execute the flight task directly based on the flight route sent by the control terminal.

FIG. 9 is a schematic structural diagram of a flight planning apparatus according to some embodiments of the present disclosure. The flight planning apparatus of FIG. 9 includes a processor 901 and a memory 902. The processor 901 and the memory 902 may be connected through a bus 903 or another manner.

The memory 902 may be used to store a computer program. The computer program may include a program instruction.

The processor 901 may be configured to call the program instruction to select the plurality of target feature points on the inclined ground object, determine the inclination angle of the inclined ground object relative to the horizontal plane based on the position information of the plurality of target feature points, and determine the control parameter of the UAV flying with respect to the inclined ground object according to the inclination angle. The control parameter may be used to determine the flight route of the UAV.

In some embodiments, the processor 901 may be configured to determine the flight route of the UAV according to the control parameter.

In some embodiments, the inclination angle of the inclined ground object relative to the horizontal plane may be the inclination angle of the target measurement area relative to the horizontal plane. The target measurement area may be a measurement area determined based on the plurality of the target feature points. The plurality of the target feature points may at least include a first target feature point, a second target feature point, and a third target feature point. In some other embodiments, the target measurement area may be a measurement area determined based on end points. The end points may include end points determined by user input.

In some embodiments, the control parameter of the UAV flying relative to the inclined ground object may include a control parameter of the UAV flying with respect to the target measurement area.

In some embodiments, the flight route may include the flight route along the inclined ground object.

In some embodiments, the processor 901 may be further configured to control the UAV to fly and execute the flight task according to the flight route.

In some embodiments, the flight task may include a photographing task. The processor 901 may be further configured to, before controlling the UAV to fly and execute the flight task according to the flight route, adjust the angle of the photographing device of the UAV according to the inclination angle to maintain the photographing device and the inclined ground object in the perpendicular state.

In some embodiments, to select the plurality of target feature points on the inclined ground object, the processor 901 may be further configured to control the UAV to fly to the first target feature point of the inclined ground object and record the position information of the first target feature point, control the UAV to fly to the second target feature point of the inclined ground object and record the position information of the second target feature point, and control the UAV to fly to the third target feature point of the inclined ground object and record the position information of the third target feature point. The second target feature point may include a feature point whose height difference with the first target feature point has an absolute value less than the first predetermined threshold. The third target feature point may include a feature point whose height difference with the first target feature point has an absolute value greater than the second predetermined threshold.

In some embodiments, the first target feature point and the second target feature point may be located at a first edge. The third target feature point may be located at a second edge. The first edge may include one of an upper edge and a lower edge of the inclined ground object. The second edge may include the other one of the upper edge and the lower edge of the inclined ground object.

In some embodiments, to determine the inclination angle of the inclined ground object with respect to the horizontal plane based on the position information of the plurality of target feature points, the processor 901 may be further configured to calculate the inclination angle of the inclined ground object with respect to the horizontal plane according to the position information of the first target feature point, the position information of the second target feature point, and the position information of the third target feature point.

In some embodiments, the processor 901 may be further configured to connect the first target feature point and the second target feature point to obtain the straight line between the first target feature point and the second target feature point, draw the parallel line of the straight line through the third target feature point, draw the first perpendicular line of the parallel line through the first target feature point, and draw the second perpendicular line of the parallel line through the second target feature point. The first vertical line and the second vertical line may intersect the parallel line at the fourth target feature point and the fifth target feature point, respectively. The processor 901 may be further configured to, according to the first target feature point, the second target feature point, the fourth target feature point, and the fifth target feature point, construct the target measurement area of the inclined ground object.

In some embodiments, to construct the target measurement area of the inclined ground object according to the first target feature point, the second target feature point, the fourth target feature point, and the fifth target feature point, the processor 901 may be further configured to adjust the position of the fourth target feature point on the parallel line and/or move the position of the fifth target feature point on the parallel line, so that the quadrilateral formed by the first target feature point, the second target feature point, the fourth target feature point, and the fifth target feature point may match the inclined ground object. The processor 901 may be further configured to determine the quadrilateral formed by the first target feature point, the second target feature point, the fourth target feature point, and the fifth target feature point to be the target measurement area.

In some embodiments, the control parameter may include a travel distance. To determine the control parameter of the UAV flying with respect to the inclined ground object according to the inclination angle, the processor 901 may be configured to obtain the distance between the UAV and the inclined ground object and determine the travel distance of the UAV flying with respect to the target measurement area according to the distance and the predetermined overlap degree.

In some embodiments, the flight task may include the photographing task. To obtain the distance between the UAV and the inclined ground object, the processor 901 may be further configured to, according to a predetermined photographing parameter, calculate the distance between the UAV and the inclined ground object. The photographing parameter may include a focal length, a pixel size, and resolution.

In some embodiments, to determine the travel distance of the UAV flying with respect to the target measurement area according to the distance and the predetermined overlap degree, the processor 901 may be further configured to, according to the distance, the picture size of the photographing device, and the predetermined overlap degree, calculate the travel distance of the UAV flying with respect to the target measurement area.

In some embodiments, the predetermined overlap degree may include the predetermined lateral overlap degree and/or the predetermined longitudinal overlap degree. The picture size of the photographing device may include the picture width and the picture length. To calculate the travel distance of the UAV flying with respect to the target measurement area according to the distance, the picture size of the photographing device, and the predetermined overlap degree, the processor 901 may be further configured to, according to the distance, the picture width, and the predetermined longitudinal overlap degree, calculate the longitudinal travel distance of the UAV flying with respect to the target measurement area, and/or, according to the distance, the picture length, and the predetermined lateral overlap degree, calculate the lateral travel distance of the UAV flying with respect to the target measurement area.

In some embodiments, to calculate the longitudinal travel distance of the UAV flying with respect to the target measurement area according to the distance, the picture width, and the predetermined longitudinal overlap degree, the processor 901 may be further configured to calculate the projection width of the picture width on the inclined ground object according to the distance, the focal length, and the picture width and calculate the longitudinal travel distance of the UAV flying with respect to the target measurement area according to the projection width and the predetermined longitudinal overlap degree.

In some embodiments, to calculate the lateral travel distance of the UAV flying with respect to the target measurement area according to the distance, the picture length, and the predetermined lateral overlap degree, the processor 901 may be further configured to calculate the projection length of the picture length on the inclined ground object according to the distance, the focal length, and the picture length of the frame and calculate the lateral travel distance of the UAV flying with respect to the target measurement area according to the projection length and the predetermined lateral overlap degree.

To simplify the description, the above method embodiments are all expressed as a series of action combinations. However, those skilled in the art should know that the present disclosure is not limited by the action sequence described, because certain steps may be performed in another sequence or simultaneously according to the present disclosure. Secondly, those skilled in the art should also know that the embodiments of the specification are all preferred embodiments, and the related actions and modules are not necessarily required by the present disclosure.

Those of ordinary skill in the art should understand that all or part of the processes in the various methods of embodiments of the present disclosure may be completed by instructing relevant hardware through a program. The program may be stored in a computer-readable storage medium. The storage medium may include a flash disk, read-only memory (ROM), random access memory (RAM), magnetic disk, CD-ROM, etc.

The flight planning method and the related apparatus provided by embodiments of the present disclosure are described in detail above. Specific examples are used in the specification to illustrate the principle and implementation of the present disclosure. The description of embodiments of the present disclosure is used to help understand the method and the core idea of the present disclosure. Meanwhile, for those of ordinary skill in the art, according to the idea of the disclosure, changes may be made to the specific implementation and the application scope. In summary, the content of the specification should not be understood as a limitation to the present disclosure.

What is claimed is:

1. A flight planning method comprising:
selecting a plurality of target feature points on an inclined ground object;
determining an inclination angle of the inclined ground object with respect to a horizontal plane based on position information of the plurality of target feature points; and
determining a control parameter of an unmanned aerial vehicle (UAV) flying with respect to the inclined ground object according to the inclination angle, the control parameter being used to determine a flight route of the UAV.

2. The method of claim 1, wherein:
determining the inclination angle of the inclined ground object with respect to the horizontal plane includes determining an inclination angle of a target measurement area with respect to the horizontal plane; and
the target measurement area is determined based on:
the plurality of target feature points that include a first target feature point, a second target feature point, and a third target feature point, or
end points determined according to a user input.

3. The method of claim 2, wherein:
determining the control parameter of the UAV flying with respect to the inclined ground object includes determining a control parameter of the UAV flying with respect to the target measurement area.

4. The method of claim 2, further comprising:
connecting the first target feature point and the second target feature point to obtain a straight line between the first target feature point and the second target feature point;
drawing a parallel line of the straight line through the third target feature point;
drawing a first perpendicular line of the parallel line through the first target feature point and a second perpendicular line of the parallel line through the second target feature point, the first perpendicular line and the second perpendicular line intersecting with the parallel line at a fourth target feature point and a fifth target feature point; and
constructing the target measurement area of the inclined ground object according to the first target feature point, the second target feature point, the fourth target feature point, and the fifth target feature point.

5. The method of claim 4, wherein constructing the target measurement area according to the first target feature point, the second target feature point, the fourth target feature point, and the fifth target feature point includes:
adjusting at least one of a position of the fourth target feature point or a position of the fifth target feature point on the parallel line to cause a quadrilateral formed by the first target feature point, the second target feature point, the fourth target feature point, and the fifth target feature point to match the inclined ground object; and
determining the quadrilateral as the target measurement area.

6. The method of claim 2, wherein:
the control parameter includes a travel distance; and
determining the control parameter of the UAV includes:
obtaining a distance between the UAV and the inclined ground object; and
determining the travel distance of the UAV flying with respect to the target measurement area according to:
the distance between the UAV and the inclined ground object, and
a predetermined overlap degree.

7. The method of claim 6, wherein:
the flight task includes a photographing task; and
obtaining the distance between the UAV and the inclined ground object includes:
calculating the distance between the UAV and the inclined ground object according to photographing parameters, the photographing parameters including a focal length, a pixel size, and a resolution.

8. The method of claim 6, wherein determining the travel distance includes:
calculating the travel distance of the UAV flying with respect to the target measurement area according to:
the distance between the UAV and the inclined ground object,
a picture size of the photographing device, and
the predetermined overlap degree.

9. The method of claim 8, wherein:
the predetermined overlap degree includes at least one of a predetermined lateral overlap degree or a predetermined longitudinal overlap degree;
the picture size of the photographing device includes a picture width and a picture length;
calculating the travel distance of the UAV flying with respect to the target measurement area according to the distance between the UAV and the inclined ground object, the picture size of the photographing device, and the predetermined overlap degree includes at least one of:
calculating the longitudinal travel distance of the UAV flying with respect to the target measurement area according to the distance between the UAV and the inclined ground object, the picture width, and the predetermined longitudinal overlap degree; or
calculating the lateral travel distance of the UAV flying with respect to the target measurement area according to the distance between the UAV and the inclined ground object, the picture length, and the predetermined lateral overlap degree.

10. The method of claim 9, wherein calculating the longitudinal travel distance of the UAV flying with respect to the target measurement area according to the distance between the UAV and the inclined ground object, the picture width, and the predetermined longitudinal overlap degree includes:
calculating a projection width of the picture width on the inclined ground object according to the distance between the UAV and the inclined ground object, a focal length, and the picture width; and
calculating the longitudinal travel distance of the UAV flying with respect to the target measurement area according to the projection width and the predetermined longitudinal overlap degree.

11. The method of claim 9, wherein calculating the lateral travel distance of the UAV flying with respect to the target measurement area according to the distance, the picture length, and the predetermined lateral overlap degree includes:
calculating a projection length of the picture length on the inclined ground object according to the distance, a focal length, and the picture length; and
calculating the lateral travel distance of the UAV flying with respect to the target measurement area according to the projection length and the horizontal longitudinal overlap degree.

12. The method of claim 1, wherein the flight route is along the inclined ground object.

13. The method of claim 1, further comprising:
controlling the UAV to fly according to the flight route and execute a flight task.

14. The method of claim 13,
wherein the flight task includes a photographing task;
the method further comprising, before controlling the UAV to fly and execute the flight task:
adjusting an angle of a photographing device of the UAV according to the inclination angle to cause the photographing device to maintain perpendicular to the inclined ground object.

15. The method of claim 1, wherein selecting the plurality of target feature points includes:
controlling the UAV to fly to a first target feature point of the inclined ground object and recording position information of the first target feature point;
controlling the UAV to fly to a second target feature point of the inclined ground object and recording position information of the second target feature point, an absolute value of a height difference between the second target feature point and the first target feature point being smaller than a first predetermined threshold; and
controlling the UAV to fly to a third target feature point of the inclined ground object and recording position information of the third target feature point, an absolute value of a height difference between the third target feature point and the first target feature point being greater than a second predetermined threshold.

16. The method of claim 15, wherein:
the first target feature point and the second target feature point are located at a first edge;
the third target feature point is located at a second edge;
the first edge includes one of an upper edge and a lower edge of the inclined ground object; and
the second edge includes another one of the upper edge and the lower edge of the inclined ground object.

17. The method of claim 15, wherein determining the inclination angle of the inclined ground object with respect to the horizontal plane includes:
calculating the inclination angle of the inclined ground object with respect to the horizontal plane according to the position information of the first target feature point, the position information of the second target feature point, and the position information of the third target feature point.

18. A computer-readable storage medium storing a computer program that, when being executed by a processor, causes the processor to execute the flight planning method of claim 1.

19. A flight planning system comprising:
an unmanned aerial vehicle (UAV); and
a control terminal configured to:
select a plurality of target feature points on an inclined ground object;
determine an inclination angle of the inclined ground object with respect to a horizontal plane based on position information of the plurality of target feature points; and
determine a control parameter of the UAV flying with respect to the inclined ground object, the control parameter being used to determine a flight route of the UAV.

20. A flight planning apparatus comprising:
a processor; and
a memory storing a computer program that, when executed by the processor, causes the processor to:
select a plurality of target feature points on an inclined ground object;
determine an inclination angle of the inclined ground object with respect to a horizontal plane based on position information of the plurality of target feature points; and
determine a control parameter of an unmanned aerial vehicle (UAV) flying with respect to the inclined ground object, the control parameter being used to determine a flight route of the UAV.
